(19) United States
(12) Patent Application Publication
(10) Pub. No.: US 2015/0310651 A1
(43) Pub. Date: Oct. 29, 2015

(54) DETECTING A READ LINE OF TEXT AND DISPLAYING AN INDICATOR FOR A FOLLOWING LINE OF TEXT

(71) Applicant: Verizon Patent and Licensing Inc., Basking Ridge, NJ (US)

(72) Inventor: Arthanari CHANDRASEKARAN, Chennai (IN)

(73) Assignee: Verizon Patent and Licensing Inc., Basking Ridge, NJ (US)

(21) Appl. No.: 14/264,718

(22) Filed: Apr. 29, 2014

(51) Int. Cl. G06T 11/60; G06F 3/16; G06F 3/01

(52) U.S. Cl. CPC G06T 11/60; G06F 3/013; G06F 3/16

(57) ABSTRACT

A device may be configured to cause a plurality of lines of text to be presented for display. The device may detect a user action performed by a user and determine a first line of text the user is reading based on the user action. The device may cause an indicator for a second line of text to be presented for display based on the first line of text. The second line of text may follow the first line of text.

### BACKGROUND

A user device may display multiple lines of text for a user to read. For example, a TV, a laptop computer, a tablet computer, or a smart phone, may display news articles, electronic books, emails, web pages, or the like. The user may read the text displayed by the user device.

### BRIEF DESCRIPTION OF THE DRAWINGS

FIG. 1 is a diagram of an overview of an example implementation described herein;

FIG. 2 is a diagram of an example environment in which systems and/or methods, described herein, may be implemented;

FIG. 3 is a diagram of example components of one or more devices of FIG. 2;

FIG. 4 is a flow chart of an example process for displaying an indicator for a line of text following a line of text that a user is reading;

FIG. 5 is a diagram of an example implementation relating to the example process shown in FIG. 4;

FIG. 6 is a diagram of an example implementation relating to the example process shown in FIG. 4; and

FIG. 7 is a diagram of an example implementation relating to the example process shown in FIG. 4.

### DETAILED DESCRIPTION OF PREFERRED EMBODIMENTS

The following detailed description of example implementations refers to the accompanying drawings. The same reference numbers in different drawings may identify the same or similar elements.

Some user devices (e.g., TVs, desktop computers, etc.) may have large displays and display long lines of text. In other words, there may be a sizeable distance between an end of a line of text and a start of following line of text. Furthermore, some user devices (e.g., smart phones, tablet computers, etc.) may display text in a small font and/or display lines of text close together to accommodate small displays. Accordingly, when a user reads an end of a line of text on a user device, it may be difficult for a reader to find the start of a following line of text to continue reading. Thus, a user may skip lines of text while reading and/or be inconvenienced by having to take time and/or effort to find a following line of text to read.

Implementations described herein may detect a line of text a user is reading and display an indicator on a following line of text. Thus, a user may easily identify a following line of text to be read regardless of a size of the display, a size of the text, and/or an amount of spacing between lines of text.

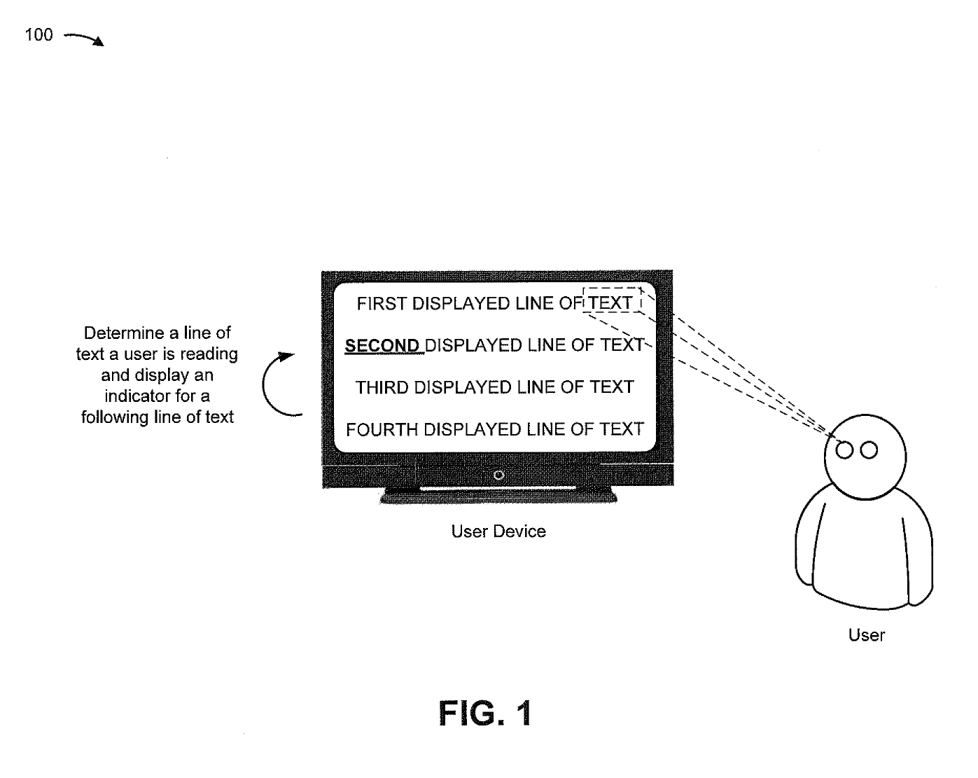

FIG. 1 is a diagram of an overview of an example implementation 100 described herein. As shown in FIG. 1, a user device may display multiple lines of text. Assume a user is reading a first line of text displayed by the user device.

The user device may detect the line of text that the user is reading (e.g., the first displayed line of text in FIG. 1). For example, the user device may use a camera to determine where the user is looking and determine a line of text the user is reading based on where the user is looking. Additionally, or alternatively, the user may be reading the text aloud and user device may use a microphone to detect the text read aloud by the user. The user device may detect the line of text that the user is reading based on the text read aloud. Furthermore, the user may use an input device (e.g., a mouse) to indicate which line of text the user is reading.

The user device may determine a following line of text (e.g., the second displayed line of text in FIG. 1) that follows the line of text the user is reading and display an indicator for the following line of text. For example, as shown in FIG. 1, the user device may bold and underline a first word in the following line of text.

Accordingly, when the user finishes reading the line of text currently being read by the user, the user may easily identify the following line of text using the displayed identifier for the following line of text.

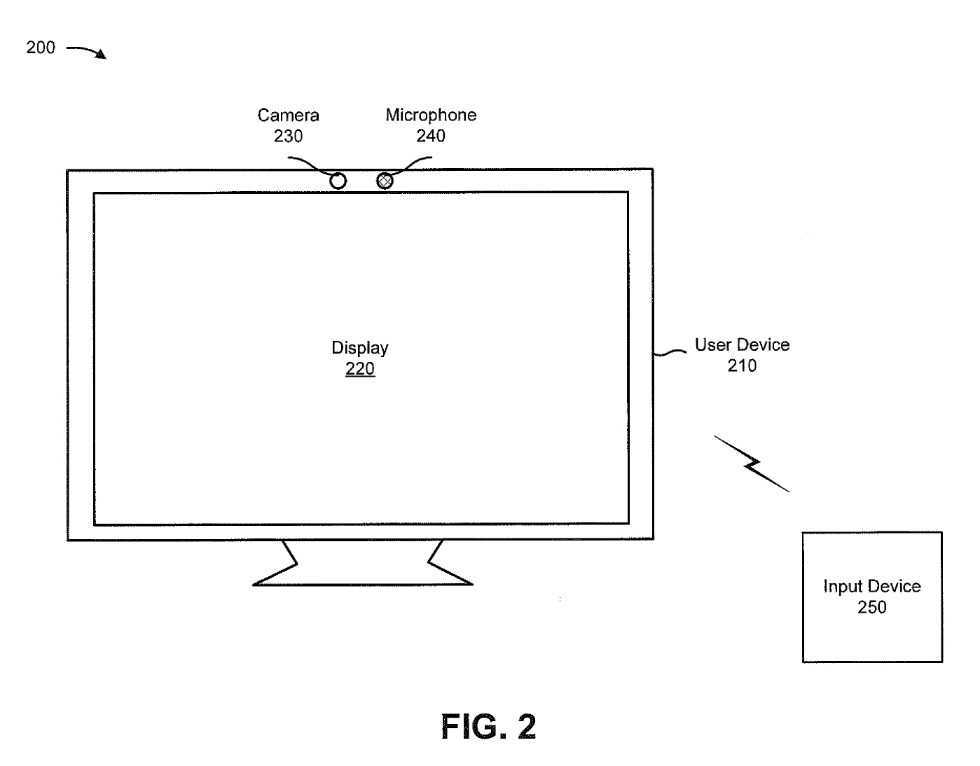

FIG. 2 is a diagram of an example environment 200 in which systems and/or methods, described herein, may be implemented. As shown in FIG. 2, environment 200 may include a user device 210 and/or an input device 250. Devices of environment 200 may interconnect via wired connections, wireless connections, or a combination of wired and wireless connections.

User device 210 may include a device capable of receiving, processing, and/or presenting information. Examples of user device 210 may include a television, a mobile phone (e.g., a smart phone, a radiotelephone, etc.), a computing device (e.g., a laptop computer, a tablet computer, a handheld computer, a set-top box, a gaming device, a head mounted display (HMD), etc.), and/or other types of devices capable of presenting information to a user. User device 210 may cause display of and/or display multiple lines of text.

In some implementations, user device 210 may include a display 220, a camera 230, a microphone 240, and/or input device 250. For example, user device 210 may be an optical HMD including display 220, microphone 240, and a camera 230 facing a user's eyes. Additionally, or alternatively, display 220, camera 230, microphone 240, and/or input device 250 may be separate devices from user device 210.

Display 220 may include technologies, such as cathode ray tube (CRT) displays, liquid crystal displays (LCDs), light-emitting diode (LED) displays, plasma displays, etc. In some implementations, display 220 may include a touchscreen that not only provides information for display, but also acts an input device. Camera 230 may include an image sensor for detecting an image. In some implementations, camera 230 may covert an optical image into an electronic signal. Microphone 240 may include an audio sensor for detecting sound. In some implementations, microphone 240 may convert a sound into an electronic signal. Input device 250 may include a device for providing inputs to user device 210. For example, input device 250 may include a mouse, a keyboard, a touchpad, a remote control, or the like.

In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

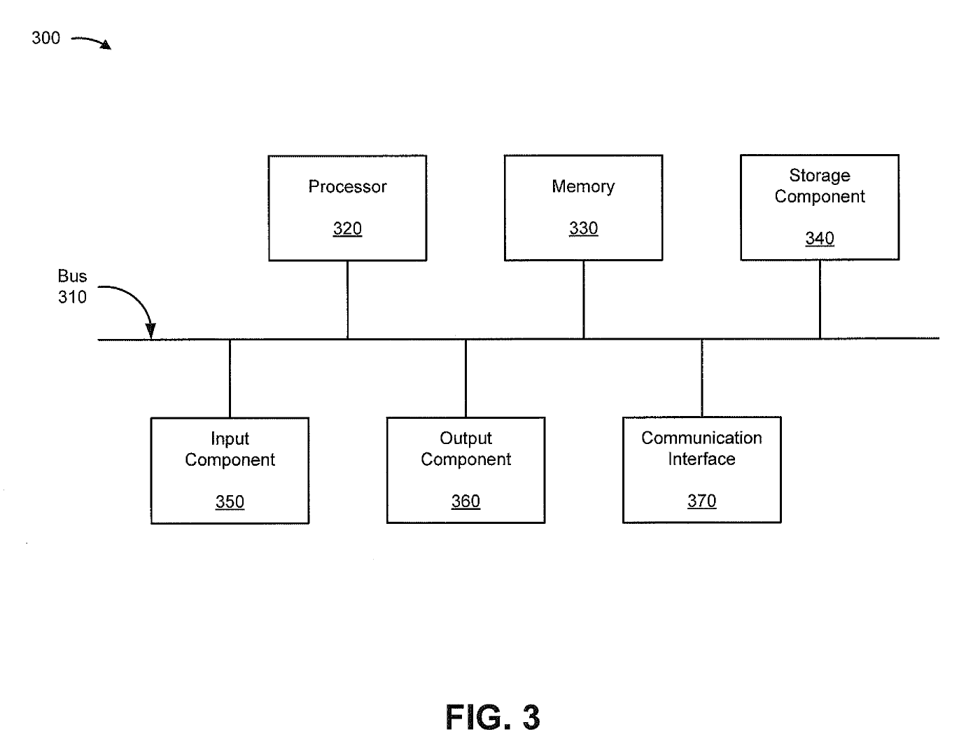

FIG. 3 is a diagram of example components of a device 300. Device 300 may correspond to user device 210, display 220, camera 230, microphone 240, and/or input device 250. In some implementations, user device 210, display 220, camera 230, microphone 240, and/or input device 250 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 may include a component that permits communication among the components of device 300. Processor 320 may include a processor (e.g., a central processing unit (CPU), a graphics processing unit (GPU), an accelerated processing unit (APU), etc.), a microprocessor, and/or any processing component (e.g., a field-programmable gate array (FPGA), an application-specific integrated circuit (ASIC), etc.) that interprets and/or executes instructions. Memory 330 may include a random access memory (RAM), a read only memory (ROM), and/or another type of dynamic or static storage device (e.g., a flash memory, a magnetic memory, an optical memory, etc.) that stores information and/or instructions for use by processor 320.

Storage component 340 may store information and/or software related to the operation and use of device 300. For example, storage component 340 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 350 may include a component that permits device 300 to receive information, such as via user input (e.g., a touch screen display, a keyboard, a keypad, a mouse, a button, a switch, a microphone, etc.). Additionally, or alternatively, input component 350 may include a sensor for sensing information (e.g., a global positioning system (GPS) component, an accelerometer, a gyroscope, an actuator, a camera, etc.). Output component 360 may include a component that provides output information from device 300 (e.g., a display, a speaker, one or more light-emitting diodes (LEDs), etc.).

Communication interface 370 may include a transceiver-like component (e.g., a transceiver, a separate receiver and transmitter, etc.) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 is provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

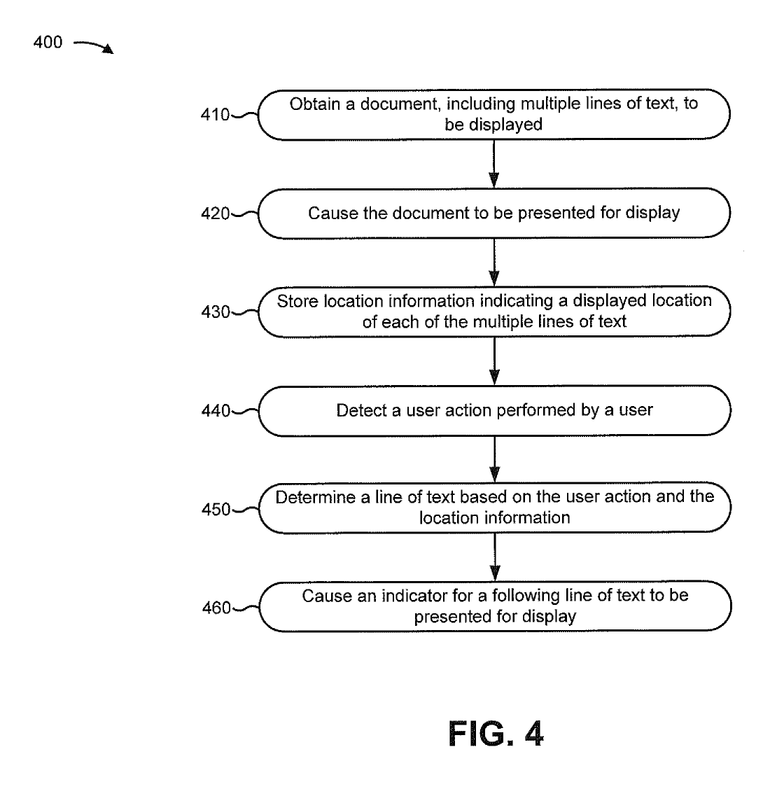

FIG. 4 is a flow chart of an example process 400 for displaying an indicator for a line of text following a line of text that a user is reading. In some implementations, one or more process blocks of FIG. 4 may be performed by user device 210.

In some implementations, user device 210 may download an application for displaying an indicator for a line of text following a line of text that a user is reading. The user may execute the application to perform this feature. Additionally, or alternatively, this feature may be built into another applications and the user may configure a setting of the application to turn on the feature.

As shown in FIG. 4, process 400 may include obtaining a document including multiple lines of text to be displayed (block 410). For example, user device 210 may obtain the document.

The document may include a text file (e.g., a word processing file, a spreadsheet, an e-book, etc.), an email, an instant message, a text message, a webpage, etc. The text may include characters (e.g., numbers, letters, symbols, etc.), words, sentences, paragraphs, etc.

In some implementations, user device 210 may store the document in a memory of user device 210 and/or a memory accessible by user device 210. User device 210 may obtain the document from the memory. Additionally, or alternatively, user device 210 may receive the document from an external device and/or network (e.g., the Internet).

As further shown in FIG. 4, process 400 may include causing the document to be presented for display (block 420). For example, user device 210 may cause display 220 to display the text in the document as multiple lines of text.

In some implementations, the document may be associated with information that indicates how text, in the document, is to be displayed. For example, the document may indicate how the text should be broken into multiple lines for display.

On the other hand, the document may not be associated with information that indicates how the text is to be displayed as the multiple lines of text. In such a case, user device 210 may break the text into the multiple lines of text for display. For example, user device 210 may determine how the text is to be displayed based on a size and/or shape of display 220, a resolution of display 220, a display setting associated with display 220, an application setting for an application (e.g., a computer program) used to display the text, a size and/or shape of a window displayed by display 220 to display the text, a length of the text, a break point in the text (e.g., an end of a word included in the text), etc.

User device 210 may provide the multiple lines of text to display 220. Display 220 may receive the multiple lines of text and display the multiple lines of text.

As further shown in FIG. 4, process 400 may include storing location information indicating a displayed location of each of the multiple lines of text (block 430). For example, user device 210 may store the location information in a memory of user device 210 and/or a memory accessible by user device 210.

The location information may indicate coordinates of the lines of text displayed on display 220. For example, the location information may indicate coordinates of a start of a line of text and/or an end of a line of text. Additionally, or alternatively, the location information may indicate coordinates of each character and/or word included in the text. User device 210 may determine the location information based on the text included in the document and a user input associated with where and how the document should be displayed on display 220.

As further shown in FIG. 4, process 400 may include detecting a user action performed by a user (block 440). For example, user device 210 may detect the user action.

In some implementations, the user action may include the user looking at a part of display 220. Accordingly, user device 210 may detect the part of display 220 at which the user is looking. For example, one or more cameras 230 may sense an image or images of the user's eyes and send the image(s) to user device 210. User device 210 may receive the image(s) of the user's eyes and/or pupils. User device 210 may calculate a distance between the user's eyes and camera 230 based on the image(s) and determine an angle the user is looking relative to camera 230 based on the direction of the user's pupils in the image(s). Based on the distance and the angle, user device 210 may determine a line of sight of the user relative to camera 230 and/or a location the user is looking relative to camera 230. User device 210 may store placement information indicating a location of display 220 and/or parts of display 220 relative to camera 230. User device 210 may determine the part of display 220 at which the user is looking based on the line of sight of the user relative to camera 230, the location the user is looking relative to camera 230, and/or the placement information.

Additionally, or alternatively, user device 210 may detect the part of display 220 at which the user is looking by tracking the movement of a user's pupil or using gaze point mapping. For example, camera 230 may include a LED that emits light (e.g., infrared light or near-infrared light) into the user's eyes. A reflection of light reflected off a cornea of an eye may be detected by camera 230 and user device 210 may determine a center position of the cornea based on the detected reflection. The center position of the reflection may not change when the user's line of sight changes. In other words, the center position of the reflection is independent of where the pupil is looking (e.g., up, down, left, right, etc.). Camera 230 may also capture an image of the user's pupil and user device 210 may determine a position of the user's pupil based on the captured image. The position of the user's pupil may change when the user's line of sight changes. Accordingly, user device 210 may compare the position of the user's pupil (and/or a change in the position of the user's pupil) to the center position of the reflection to determine the user's line of sight. Thus, user device 210 may determine the part of display 220 at which the user is looking based on the line of sight of the user relative to camera 230.

In some implementations, the user action may include the user reading the text aloud. Accordingly, user device 210 may detect the text that the user is reading aloud. For example, microphone 240 may detect the sound emitted by the user reading the text aloud and generate sound information indicating the sound. Microphone 240 may send the sound information to user device 210 and user device 210 may receive the sound information. User device 210 may store voice recognition software used to detect text from a sound. User device 210 may execute the voice recognition software to detect the text from the sound information.

In some implementations, the user action may include providing an input to user device 210. For example, the user may touch display 220 and move a finger along the displayed lines of text as the user is reading the text to indicate which word and/or line of text is being read by the user. Additionally, or alternatively, a user may touch display 220 and move a finger perpendicular to the displayed lines of text as the user reads the text to indicate which line of text the user is reading. A touchscreen included in display 220 may detect the user's touching of display 220 as an input indicating a part of the display touched by the user's finger. Additionally, or alternatively, the user may use input device 250 (e.g., a mouse, a keyboard, a touchpad, a remote, etc.) to move a displayed cursor along the displayed text and/or perpendicular to the displayed lines of text.

As further shown in FIG. 4, process 400 may include determining a line of text based on the user action and the location information (block 450). For example, user device 210 may determine a line of text the user is looking at, reading, and/or associated with a user input.

In some implementations, user device 210 may determine a line of text at which the user is looking and/or reading. For example, user device 210 may determine the line of text based on the detected part of display 220 at which is user looking and the location information, which indicates which line of text is displayed at that part of display 220. For instance, user device 210 may query the location information using coordinates associated with the part of the display at which the user is looking and obtain information identifying a line of text, a word included in the line of text, and/or a character included in the line of text that is associated with the coordinates.

In some implementations, user device 210 may determine a line of text from which the user is reading aloud. For example, user device 210 may determine the line of text based on the detected text that the user is reading aloud and the location information. For instance, user device 210 may query the location information using the most recently detected word(s) read aloud by the user and obtain information identifying a line of text, a word included in the line of text, and/or a character included in the line of text that is associated with the most recently detected word(s).

In some implementations, user device 210 may determine a line of text associated with a detected user input. For example, user device 210 identify the line of text based on the user input and the location information. For instance, user device 210 may query the location information using coordinates associated with the user input (e.g., a displayed location of the cursor and/or a location of where the user touched display 220) and obtain information identifying a line of text, a word included in the line of text, and/or a character included in the line of text that is associated with the coordinates.

In some implementations, user device 210 may determine a line of text based on more than one of the described techniques (e.g., user actions detected by camera 230, microphone 240, and/or input device 250). For example, user device 210 may determine a line of text based on where the user is looking and text being read aloud by the user. Additionally, or alternatively, the techniques may be weighted and combined to determine the line of text. In some implementations, one technique may be given priority over another technique if the techniques result in conflicting lines of text being determined. For example, reading aloud may trump where the user is looking, which may trump using input device 250. A user may configure user device 210 to detect the user action using one or more of the described techniques and/or set weights or priorities for the techniques.

As further shown in FIG. 4, process 400 may include causing an indicator to be presented for display for a following line of text (block 460). For example, user device 210 may cause display 220 to display the indicator.

The following line of text may include a line of text immediately following the line of text determined at block 450. For example, the following line of text may be a line of text displayed directly below the line of text determined at block 450. Additionally, or alternatively, the following line of text may include one or more lines of text of following the line of text determined at block 450.

User device 210 may determine the following line of text based on the line of text determined at block 450 and the text included in the document.

In some implementations, the indicator may emphasize the following line of text. For example, the indicator may include a highlighting of text, a bolding of text, an underlining of text, a change in a font of text, a change in a color of text, a change in a size of text, a blinking of text, and/or any other manner of directing a user's attention to the following line of text. Accordingly, user device 210 may cause display 220 to emphasize at least a part of the following line of text. For example, user device 210 may cause display 220 to emphasize a part at the start of the following line (e.g., a first word of the following line). Additionally, or alternatively, user device 210 may cause display 220 to emphasize more than the first word, such as the entire following line of text.

In some implementations, the indicator may include an image and/or an icon displayed on and/or adjacent to the following line of text. For example, the indicator may be displayed to the left of a start of the following line of text and/or to the right of an end of the following line of text. Accordingly, user device 210 may cause display 220 to display an image and/or icon on and/or adjacent to the following line of text.

In some implementations, the indicator may include a connector that connects the determined line of text to the following line of text. For example, the indicator may be a guide line that connects and end of the determine line of text to a start of the following line of text. Accordingly, user device 210 may cause display 220 to display a connector that connects the determined line of text to the following line of text.

In some implementations, user device 210 may cause display 220 to display the indicator for more than one following line of text. For example, user device 210 may cause display 220 to display the indicator on all remaining lines of text following the determined line of text.

Additionally, or alternatively, user device 210 may cause display 220 to display the indicator on or near the line determine at block 450. For example, user device 210 may cause display 220 to display the indicator on an end part of the determined line and/or a part of the determined line after a word being read by the user.

In some implementations, user device 210 may cause display 220 to display the indicator for the following line of text when user device 210 detects the user is reading an end portion of the line of text determined at block 450. For example, user device 210 may not cause display of the indicator while the reader is reading a beginning portion of the line of text determined at block 450, and wait until the user is reading an end portion of the line of text determined at block 450 to display the indicator.

In some implementations, the indicator may be configurable by a user. For example, user device 210 may provide an interface to the user that allows the user to specify the type of indicator and/or the amount text to be emphasized. Additionally, or alternatively, the user may be allowed to specify a combination of types of indicators and/or specify an indicator on a per application basis (e.g., based on the application used to display the text).

After user device 210 causes display 220 to display the indicator, process 400 may include user device 210 detecting another user action, determining another line of text based on the user action, and causing display 220 to display another indicator. In other words, process 400 may be repeated. In some implementations, a previously displayed indicator may no longer be displayed when a subsequent indicator is displayed.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

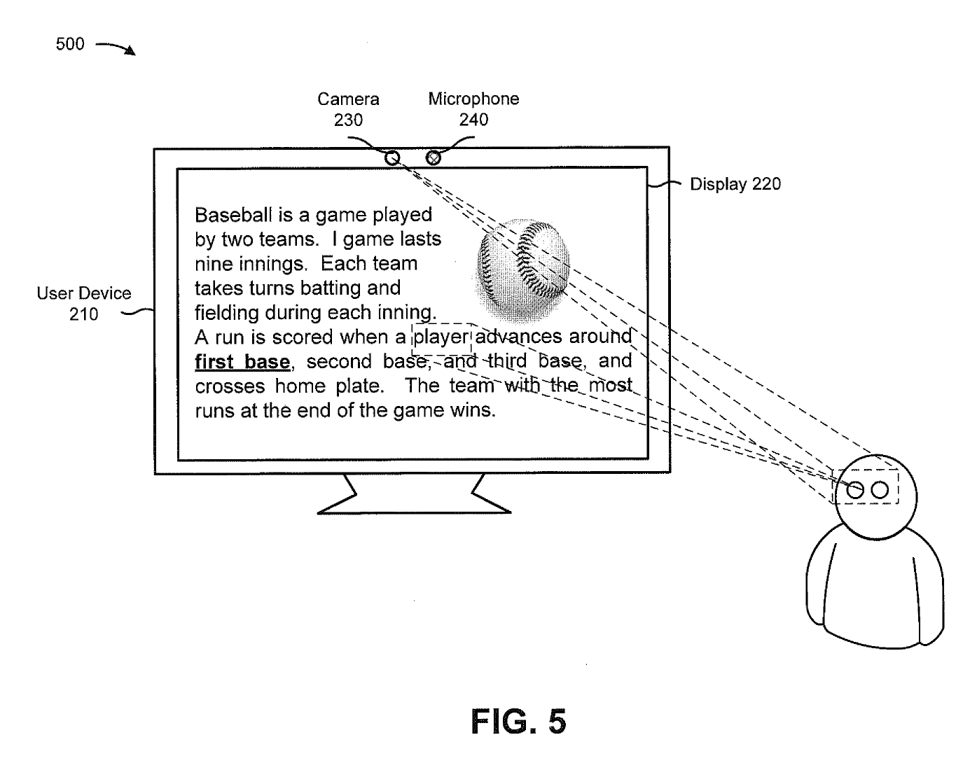

FIG. 5 is a diagram of an example implementation 500 relating to example process 400 shown in FIG. 4. FIG. 5 shows an example of displaying an indicator for a line of text following a line of text at which a user is looking.

As shown in FIG. 5, user device 210 may cause display 220 to display multiple lines of text. Assume a user is looking at the word “player” in a line of text starting with “a run is scored.” Further, assume camera 230 captures an image of the user's eyes. User device 210 may determine that the user is looking at the word “player” in the line of text based on the image. User device 210 may determine that a following line of text is a line of text immediately below the line of text starting with “a run is scored.” In other words, user device 210 may determine that the following line of text is the line of text starting with “first base.”

As further shown in FIG. 5, user device 210 may cause display 220 to display an indicator on the following line of text. For example, user device 210 may cause display 220 to bold and underline the words “first base” in the following line of text. Accordingly, when the user finishes reading the line of text starting with “a run is scored,” the user may easily identify the following line of text that starts with “first base.”

As indicated above, FIG. 5 is provided merely as an example. Other examples are possible and may differ from what was described with regard to FIG. 5.

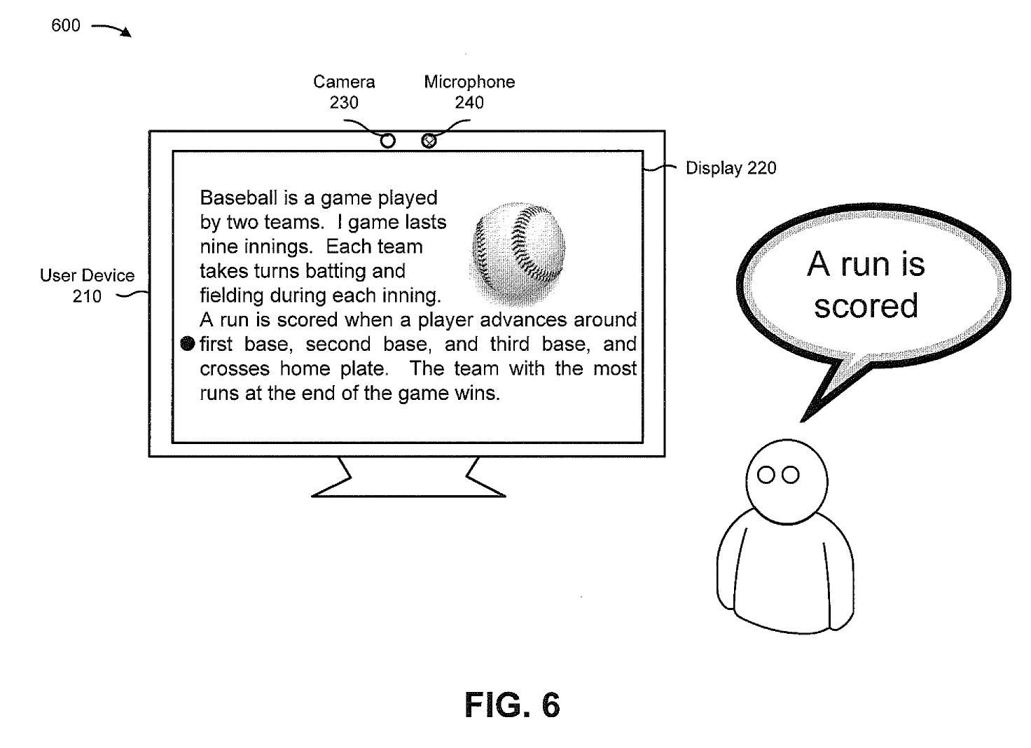

FIG. 6 is a diagram of an example implementation 600 relating to example process 400 shown in FIG. 4. FIG. 6 shows an example of displaying an indicator for a line of text following a line of text that a user is reading aloud.

As shown in FIG. 6, user device 210 may cause display 220 to display multiple lines of text. Assume a user is reading the text aloud and has most recently read “a run is scored.” Microphone 240 may detect the sound made by the user reading the text aloud and user device 210 may determine that the user just read “a run is scored” aloud. User device 210 may determine that the user is reading the line of text starting with “a run is scored” based on the text read aloud. User device 210 may determine that a following line of text is a line of text immediately below the line of text starting with “a run is scored.” In other words, user device 210 may determine that the following line of text is the line of text starting with “first base.”

As further shown in FIG. 6, user device 210 may cause display 220 to display an indicator adjacent to the following line of text. For example, user device 210 may cause display 220 to display an icon to the left of the following line of text (shown as a black circle in FIG. 6). Accordingly, when the user finishes reading the line of text starting with “a run is scored,” the user may easily identify the following line of text that starts with “first base.”

As indicated above, FIG. 6 is provided merely as an example. Other examples are possible and may differ from what was described with regard to FIG. 6.

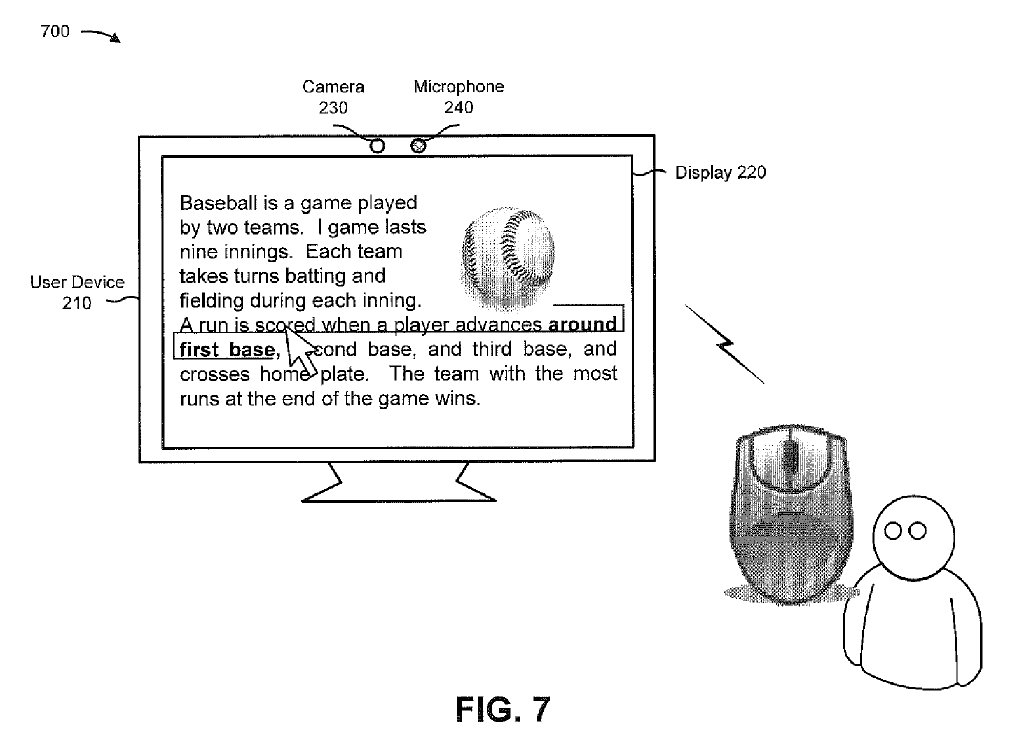

FIG. 7 is a diagram of an example implementation 700 relating to example process 400 shown in FIG. 4. FIG. 7 shows an example of displaying an indicator for a line of text following a line of text that a user indicated using input device 250.

As shown in FIG. 7, user device 210 may cause display 220 to display multiple lines of text. Assume the user is using input device 250 (e.g., a mouse) to move a cursor along the text as the user reads the text. For example, the user may use the cursor to point to the word “scored” as the user is reading the line starting with “a run is scored.” User device 210 may determine that the user is reading the line of text starting with “a run is scored” based on the cursor pointing to the word “scored.” User device 210 may determine that a following line of text is a line of text immediately below the line of text starting with “a run is scored.” In other words, user device 210 may determine that the following line of text is the line of text starting with “first base.”

As further shown in FIG. 7, user device 210 may cause display 220 to display an indicator on the line of text starting with “a run is scored” (e.g., a line being read) and on the following line of text starting with “first base.” For example, user device 210 may cause display 220 to bold the last word (e.g., “around”) in the line being read and a first two words (e.g., “first base”) in the following line. Furthermore, user device 210 may cause display 220 to display a connecting line that connects the end of the line being read to the start of the following line. Accordingly, when the user finishes reading the line of text starting with “a run is scored,” the user may easily identify the following line of text that starts with “first base.”

As indicated above, FIG. 7 is provided merely as an example. Other examples are possible and may differ from what was described with regard to FIG. 7.

Implementations described herein may detect a line of text a user is reading and display an indicator for a following line of text. Thus, a user may easily identify a following line of text to be read regardless of a size of a display, a size of the text, and/or an amount of spacing between lines of text.

The foregoing disclosure provides illustration and description, but is not intended to be exhaustive or to limit the implementations to the precise form disclosed. Modifications and variations are possible in light of the above disclosure or may be acquired from practice of the implementations.

To the extent the aforementioned implementations collect, store, or employ personal information provided by individuals, it should be understood that such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

As used herein, the term component is intended to be broadly construed as hardware, firmware, or a combination of hardware and software.

Certain user interfaces have been described herein and/or shown in the figures. A user interface may include a graphical user interface, a non-graphical user interface, a text-based user interface, etc. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A device, comprising:
one or more processors to:
cause a plurality of lines of text to be presented for display;
detect a user action performed by a user in relation to the plurality of lines of text;
determine a first line of text based on the user action,
the first line of text being included in the plurality of lines of text; and
cause an indicator for a second line of text to be presented for display based on the first line of text,
the second line of text being included in the plurality of lines of text, and
the second line of text following the first line of text.

2. The device of claim 1, where the one or more processors, when determining the first line of text, are further to:
determine the first line of text being read by the user based on the user action.

3. The device of claim 1, where the user action includes the user looking at a display displaying the plurality of lines of text, and
where the one or more processors, when detecting the user action, are further to:
detect a part of the display at which the user is looking, and
where the one or more processors, when determining the first line of text, are further to:
determine the first line of text at which the user is looking based on the part of the display at which the user is looking.

4. The device of claim 3, where the one or more processors are further to:
store location information indicating the part of the display at which the first line of text is displayed, and
where the one or more processors, when determining the first line of text, are further to:
determine the first line of text based on the part of the display at which the user is looking and the location information.

5. The device of claim 3, where the one or more processors, when detecting the part of the display at which the user is looking, are further to:
receive an image of the user;
determine a line of sight of the user based on the image; and
detect the part of the display based on the line of sight of the user.

6. The device of claim 1, where the user action includes reading a part of the plurality of lines of text aloud, and
where the one or more processors, when detecting the user action, are further to:
detect the part of the plurality of lines of text read aloud by the user, and
where the one or more processors, when determining the first line of text, are further to:
determine the first line of text based on the part of the plurality of lines of text read aloud by the user,
the first line of text including the part of the plurality of lines of text read aloud.

7. The device of claim 6, where the one or more processors are further to:
store location information indicating that the part of the plurality of lines of text is included in the first line of text, and
where the one or more processors, when determining the first line of text, are further to:
determine the first line of text based on the part of the plurality of lines of text read aloud and the location information.

8. A computer-readable medium storing instructions, the instructions comprising:
one or more instructions that, when executed by one or more processors, cause the one or more processors to:
cause a plurality of lines of text to be presented for display;
detect a user action performed by a user in relation to the plurality of lines of text;
determine a first line of text read by the user based on the user action,
the first line of text being included in the plurality of lines of text;
identify a second line of text based on the first line of text,
the second line of text being included in the plurality of lines of text, and
the second line of text being after the first line of text; and
cause the second line of text to be visually distinguished from among a remaining portion of the plurality of lines of text when the second line of text is rendered for display.

9. The computer-readable medium of claim 8, where the one or more instructions, when executed by the one or more processors to detect the user action, further cause the one or more processors to:
detect a displayed location of a cursor based on a user input, and
where the one or more instructions, when executed by the one or more processors to determine the first line of text, further cause the one or more processors to:
determine the first line of text based on the displayed location of the cursor.

10. The computer-readable medium of claim 9, where the one or more instructions, when executed by the one or more processors, further cause the one or more processors to:
store location information indicating a coordinate associated with the first line of text, and
where the one or more instructions, when executed by the one or more processors to determine the first line of text, further cause the one or more processors to:
determine the first line of text based on the displayed location of the cursor and the location information.

11. The computer-readable medium of claim 8, where the one or more instructions, when executed by the one or more processors to detect the user action, further cause the one or more processors to:
detect a coordinate of a part of a display touched by the user,
where the one or more instructions, when executed by the one or more processors to determine the first line of text, further cause the one or more processors to:
determine the first line of text based on the coordinate of the part of the display touched by the user.

12. The computer-readable medium of claim 11, where the one or more instructions, when executed by the one or more processors, further cause the one or more processors to:
store location information indicating a coordinate associated with the first line of text, and
where the one or more instructions, when executed by the one or more processors to determine the first line of text, further cause the one or more processors to:
determine the first line of text based on the coordinate of the part of the display touched by the user and the location information.

13. The computer-readable medium of claim 8, where the one or more instructions, when executed by the one or more processors, further cause the one or more processors to:
receive a document that includes the plurality of lines of text; and
divide the document into the plurality of lines of text for display on a display based on at least one of:
a size of the display,
a resolution of the display,
a display setting associated with the display,
an application setting for an application used to display the document on the display,
a size of a window displayed by the display to display the document,
a length of the document, or
a break point in the document.

14. The computer-readable medium of claim 8, where the one or more instructions, when executed by the one or more processors to cause the second line of text to be visually distinguished, further cause the one or more processors to:
cause the second line of text to be visually distinguished by emphasizing a first word of the second line of text.

15. A method, comprising:
causing, by a device, a plurality of lines of text to be presented for display;
detecting, by the device, a user action in relation to the plurality of lines of text;
determining, by the device, a first line of text associated with the user action,
the first line of text being included in the plurality of lines of text; and
causing, by the device, an indicator corresponding to a second line of text to be presented for display based on the first line of text,
the second line of text being included in the plurality of lines of text, and
the second line of text following the first line of text.

16. The method of claim 15, where the indicator is displayed on at least a beginning portion of the second line of text.

17. The method of claim 15, where the indicator is displayed adjacent to the second line of text.

18. The method of claim 15, where the indicator is displayed on a beginning portion of the second line of text and an ending portion of the first line of text.

19. The method of claim 15, where the indicator connects an end of the first line of text and a start of the second line of text.

20. The method of claim 15, where the indicator includes at least one of:
a highlighting of text in the second line of text,
a bolding of text in the second line of text,
an underlining of text in the second line of text,
a change in a font of text in the second line of text,
a change in a color of text in the second line of text,
a change in a size of text in the second line of text, or
a blinking of text in the second line of text.
